(19) United States
(12) Patent Application Publication
(10) Pub. No.: US 2008/0073628 A1
(43) Pub. Date: Mar. 27, 2008

(54) Flame-Retardant Resin Composition

(75) Inventors: Takao Michinobu, Osaka (JP); Hiroshi Tsuneishi, Osaka (JP)

Correspondence Address: SUGHRUE MION, PLLC, 2100 PENNSYLVANIA AVENUE, N.W., SUITE 800, WASHINGTON, DC, 20037, US

(73) Assignee: KANEKA CORPORATION, Osaka-shi (JP)

(21) Appl. No.: 11/662,760

(22) PCT Filed: Sep. 27, 2005
(86) PCT No.: PCT/JP05/17674

§ 371 Date: Mar. 14, 2007

(30) Foreign Application Priority Data
Sep. 30, 2004 (JP) 2004-286314

(51) Int. Cl. C09K 21/14

(52) U.S. Cl. 252/609

(57) ABSTRACT

An object of the present invention is to provide a novel flame-retardant resin composition capable of exhibiting high flame retardancy without incorporation of flame retardants containing halogen atoms, phosphorus atoms, nitrogen atoms, and the like. A flame-retardant resin composition of the present invention includes a resin component composed of a polyphenylene ether resin (A) and an aromatic vinyl resin (B); a silicone compound (C) represented by the average compositional formula (1) below; and a metal silicate compound (D) having a pH of 8.0 or more and a volume-average particle size of 1 nm to 100 μm: R¹ₘR²ₙSiO_{(4-m-n)/2} (1) (wherein R¹ represents an aliphatic hydrocarbon group; R² represents an aromatic hydrocarbon group; and m and n each represent a number satisfying the relationships: 1.1≦m+n≦1.7 and 0.4≦n/m≦2.5).

### TECHNICAL FIELD

The present invention relates to a polyphenylene ether resin composition which is free of halogen atoms, phosphorus atoms, nitrogen atoms, and the like and which is highly flame-retardant.

### BACKGROUND ART

Polyphenylene ether resins have excellent dimensional stability, heat resistance, electrical properties, and lightweight properties, and thus are used, for example, in the fields of electronic and electrical components, such as housings, chassis, and high-voltage components for televisions, personal computers, printers, and the like, OA equipment, general merchandise, and heat-resistant trays for ICs. In the electronic and electrical fields, etc. described above, in consideration of safety against fires, strict standards are set for flame retardancy of materials to be used. In the past, halogen-based or phosphorus-based flame retardants were used to impart flame retardancy to polyphenylene ether resin compositions. In recent years, because of increased concern about environmental issues, in particular, in Europe, various studies have been conducted on the use of halogen-free flame retardants, such as phosphorus-based flame retardants.

However, when flame retardancy is imparted to polyphenylene ether resins by the use of a phosphate ester compound, red phosphorus, or the like, which is a phosphorus-based flame retardant, the polyphenylene ether resins have high molding temperatures, causing problems, such as generation of odors during extrusion/molding and occurrence of mold contamination. Moreover, heat resistance of the resins is lowered. Under these circumstances, a highly flame-retardant polyphenylene ether resin which is free of halogen compounds or phosphorus compounds has been desired.

As the method for imparting flame retardancy to polyphenylene ether resins without using a compound containing halogen atoms, phosphorus atoms, and the like, use of silicone compounds has been proposed. For example, a thermoplastic resin composition containing a polyorganosiloxane and a polyphenylene ether is disclosed (for example, refer to Patent Document 1). Also, a method in which a specific phenylsiloxane fluid or a silicone resin is blended has been proposed (for example, refer to Patent Documents 2 and 3). These silicone compounds impart flame retardancy to a single polyphenylene ether resin to a certain extent, but cannot sufficiently impart flame retardancy to a polyphenylene ether resin combined with another resin. That is, polyphenylene ether resins are often used in the form of alloys with aromatic vinyl resins in order to improve flowability. However, when the silicone compounds are simply incorporated in such alloys, there is a problem that flame retardancy undesirably decreases. Recently, several techniques have been disclosed for imparting flame retardancy to alloys of polyphenylene ether resins and aromatic vinyl resins by incorporating specific silicone compounds in the alloys. For example, a technique in which a silicone resin having an R₂SiO_{2/2} unit and an RSiO_{3/2} unit is incorporated is disclosed (for example, refer to Patent Documents 4 and 5). However, with a test piece having a thickness of 1.6 mm or less, high flame retardancy that conforms to UL-94 V-0 (USA Underwriters Laboratories standard) has not been obtained.

On the other hand, as the technique for imparting flame retardancy to polyphenylene ether resins other than the technique of using silicone compounds, a method has been proposed in which a specific metal silicate is incorporated (for example, refer to Patent Document 6). However, this method is not effective for alloys of polyphenylene ether resins and aromatic vinyl resins. Furthermore, an alloy composition of a polyphenylene ether resin and an aromatic vinyl resin containing a silicone compound having an RSiO_{3/2} unit as a main unit and an inorganic filler including silicon element has been proposed (for example, refer to Patent Document 7). However, the alloy composition has insufficient flame retardancy, and further improvement is required.

[Patent Document 1] U.S. Pat. No. 3,737,479

[Patent Document 2] Japanese Examined Patent Application Publication No. 6-62843

[Patent Document 3] Japanese Unexamined Patent Application Publication No. 2001-294743

[Patent Document 4] Japanese Unexamined Patent Application Publication No. 2000-178436

[Patent Document 5] Japanese Unexamined Patent Application Publication No. 2000-297209

[Patent Document 6] Japanese Unexamined Patent Application Publication No. 2003-82218

[Patent Document 7] Japanese Unexamined Patent Application Publication No. 2002-97374

### DISCLOSURE OF INVENTION

### Problems to be Solved by the Invention

It is an object of the present invention to provide a polyphenylene ether resin composition which is free of halogens and phosphorus atoms, which is highly flame-retardant, and which has excellent heat resistance.

### Means for Solving the Problems

In view of the situation described above, the present inventors have focused attention on the fact that a silicone resin having a specific structure exhibits an effect of imparting flame retardancy to a certain extent even in an alloy of a polyphenylene ether resin and an aromatic vinyl resin, and have conducted intensive studies on the improvement of the flame retardancy. As a result, it has been found that in combination with a specific inorganic compound, even by addition of a small amount of a silicone compound, excellent flame retardancy can be imparted to the resin composition and heat resistance originally possessed by the resin is not degraded. Thereby, the present invention has been completed.

That is, the present invention relates to a flame-retardant resin composition comprising a resin component including 30 to 100 parts by weight of a polyphenylene ether resin (A) and 0 to 70 parts by weight of an aromatic vinyl resin (B); a silicone compound (C) in an amount of 0.1 to 20 parts by weight per 100 parts by weight of the resin component, the silicone compound being represented by average compositional formula (1):
R¹ₘR²ₙSiO_{(4-m-n)/2} (1)
(wherein R¹ represents a monovalent aliphatic hydrocarbon group having 1 to 4 carbon atoms; R² represents a monovalent aromatic hydrocarbon group having 6 to 24 carbon atoms; there may be two or more kinds of R¹s and two or more kinds of R²s, respectively; and m and n each represent a number satisfying the relationships: 1.1≦m+n≦1.7 and 0.4≦n/m≦2.5), the silicone compound having a SiO₂ unit in an amount of 10 mole percent or more of all Si atoms; and a metal silicate compound (D) in an amount of 0.1 to 20 parts by weight per 100 parts by weight of the resin component, the metal silicate compound having a pH of 8.0 or more, containing 30% by weight or more of a SiO₂ unit, and having a volume-average particle size of 1 nm to 100 μm.

A preferred embodiment relates to the flame-retardant resin composition, wherein the resin component includes 30 to 95 parts by weight of the polyphenylene ether resin (A) and 5 to 70 parts by weight of the aromatic vinyl resin (B).

A preferred embodiment relates to any of the flame-retardant resin compositions described above, further including 0.005 to 1 part by weight of a fluorocarbon resin (E).

A preferred embodiment relates to any of the flame-retardant resin compositions described above, wherein the silicone compound as the component (C) has an R³SiO_{3/2} unit (wherein R³ is selected from the group consisting of alkyl groups having 1 to 4 carbon atoms and aromatic groups having 6 to 24 carbon atoms, and R³s may be the same or different) and an R⁴₂SiO_{2/2} unit (wherein each R⁴ is selected from the group consisting of alkyl groups having 1 to 4 carbon atoms and aromatic groups having 6 to 24 carbon atoms, and R⁴s may be the same or different).

A preferred embodiment relates to any of the flame-retardant resin compositions described above, wherein the silicone compound as the component (C) has a main chain skeleton composed of only an R³SiO_{3/2} unit (wherein R³ is selected from the group consisting of alkyl groups having 1 to 4 carbon atoms and aromatic groups having 6 to 24 carbon atoms, and R^{3s} may be the same or different) and a SiO₂ unit.

A preferred embodiment relates to any of the flame-retardant resin compositions described above, wherein the silicone compound as the component (C) has a main chain skeleton composed of only an R⁴₂SiO_{2/2} unit (wherein each R⁴ is selected from the group consisting of alkyl groups having 1 to 4 carbon atoms and aromatic groups having 6 to 24 carbon atoms, and R⁴s may be the same or different) and a SiO₂ unit.

A preferred embodiment relates to any of the flame-retardant resin compositions described above, wherein the silicone compound as the component (C) has a number-average molecular weight in the range of 1,000 to 200,000.

A preferred embodiment relates to any of the flame-retardant resin compositions described above, wherein the metal silicate compound as the component (D) contains at least one metal element selected from K, Na, Li, Ca, Mn, Ni, Mg, Fe, Al, Ti, Zn, and Zr.

A preferred embodiment relates to any of the flame-retardant resin compositions described above, wherein the resin composition has a deflection temperature of 135° C. or higher under a load of 1.82 MPa.

### ADVANTAGES

A flame-retardant resin composition of the present invention has highly excellent flame retardancy even without the use of a commonly used flame retardant containing chlorine, bromine, phosphorus, nitrogen, or the like, and properties originally possessed by the resin are not significantly degraded. Furthermore, the flame-retardant resin composition can be relatively easily synthesized using inexpensive starting materials. Such a flame-retardant resin composition is highly useful industrially.

### BEST MODE FOR CARRYING OUT THE INVENTION

The present invention will be described in detail below.

A polyphenylene ether resin (A) that can be used in the present invention is a polymer or a copolymer composed of repeating units represented by general formula [a] and/or [b]: 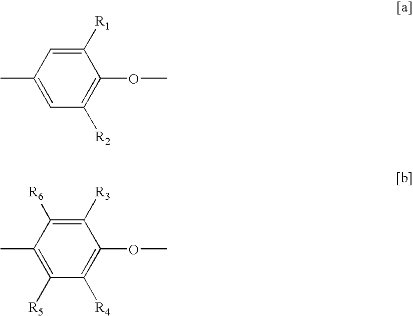
(wherein R₁, R₂, R₃, R₄, R₅, and R₆ each represent a monovalent group, such as an alkyl group having 1 to 4 carbon atoms, an aryl group, a halogen, or hydrogen, and R₅ and R₆ are not hydrogen at the same time).

Representative examples of the homopolymer as the polyphenylene ether resin (A) include homopolymers, such as poly(2,6-dimethyl-1,4-phenylene ether), poly(2-methyl-6-ethyl-1,4-phenylene ether), poly(2,6-diethyl-1,4-phenylene ether), poly(2-ethyl-6-n-propyl-1,4-phenylene ether), poly(2,6-di-n-propyl-1,4-phenylene ether), poly(2-methyl-6-n-butyl-1,4-phenylene ether), poly(2-ethyl-6-isopropyl-1,4-phenylene ether), poly(2-methyl-6-chloroethyl-1,4-phenylene ether), poly(2-methyl-6-hydroxyethyl-1,4-phenylene ether), and poly(2-methyl-6-chloroethyl-1,4-phenylene ether).

Examples of the polyphenylene ether copolymer includes a copolymer of 2,6-dimethylphenol and 2,3,6-trimethylphenol, a copolymer of 2,6-dimethylphenol and o-cresol, or a copolymer of 2,6-dimethylphenol, 2,3,6-trimethylphenol, and o-cresol. In the present invention, the polyphenylene ether copolymer includes a polyphenylene ether copolymer mainly composed of a polyphenylene ether structure.

Furthermore, the polyphenylene ether resin (A) of the present invention may contain various other phenylene ether units, which have been proposed to be present in known polyphenylene ether resins, as partial structures without departing from the spirit of the present invention. Examples of the phenylene ether units that have been proposed to be present in a small amount include a 2-(dialkylaminomethyl)-6-methylphenylene ether unit and a 2-(N-alkyl-N-phenylaminomethyl)-6-methylphenylene ether unit described in Japanese Patent Application No. 63-12698 and Japanese Unexamined Patent Application Publication No. 63-301222. Furthermore, a polyphenylene ether resin having a main chain to which a small amount of diphenoquinone or the like is bonded is also included.

The polyphenylene ether resin (A) used in the present invention preferably has a number-average molecular weight of 1,000 to 100,000 and more preferably 6,000 to 60,000. In the present invention, the term “number-average molecular weight” means a number-average molecular weight in terms of polystyrene calculated using a polystyrene standard calibration curve determined by gel permeation chromatography (hereinafter also referred to as “GPC”).

An aromatic vinyl resin (B) of the present invention is a polymer of at least one aromatic vinyl compound or a copolymer, a block copolymer, or a graft copolymer of at least one aromatic vinyl compound and at least one olefin compound.

The aromatic vinyl compound is, for example, at least one compound selected from styrene, methylstyrene, ethylstyrene, dimethylstyrene, chlorostyrene, α-methylstyrene, and vinyltoluene. The olefin compound is, for example, at least one olefin compound selected from monoolefins, such as ethylene, propylene, 1-butene, and isobutylene; conjugated diolefins, such as butadiene, isoprene, and 1,3-pentadiene; and nonconjugated diolefins, such as 1,4-hexadiene, norbornene, and norbornene derivatives.

As the aromatic vinyl resin (B), a block copolymer having an aromatic vinyl compound polymer block and a polymer block mainly composed of a conjugated diene compound is preferably used. As the aromatic vinyl compound, one or two or more compounds are selected from styrene, α-methylstyrene, vinyltoluene, and the like. Among these, styrene is particularly preferred.

As the conjugated diene compound, one or two or more compounds are selected from butadiene, isoprene, 1,3-pentadiene, and the like. Among these, butadiene and/or isoprene are particularly preferred. The weight ratio of the content of the aromatic vinyl compound to the content of the conjugated diene compound is preferably in the range of 50/50 to 90/10, and more preferably in the range of 55/45 to 85/15. If the content of the aromatic vinyl compound is less than 50% by weight, phase separation due to poor compatibility may occur when a resin composition is molded, and flowability may be adversely affected.

The above-described block copolymer preferably has a number-average molecular weight of 2,000 to 500,000 and more preferably 20,000 to 300,000. The molecular weight distribution Mw/Mn (the ratio of the weight-average molecular weight Mw to the number-average molecular weight Mn) is preferably in the range of 1.05 to 10. Examples of the molecular structure of the block copolymer include linear, branched, and radial structures, and combinations thereof. Among these, a linear structured one is more preferred.

Examples of a method for producing the block copolymer include methods described in Japanese Examined Patent Application Publication No. 36-19286, Japanese Examined Patent Application Publication No. 43-14979, Japanese Examined Patent Application Publication No. 49-36957, Japanese Examined Patent Application Publication No. 48-2423, and Japanese Examined Patent Application Publication No. 48-4106. In each of these methods, an aromatic vinyl compound and a conjugated diene compound are block-copolymerized in a hydrocarbon solvent using an organolithium compound or the like as an anionic polymerization initiator, and as necessary, using a vinylating agent, a coupling agent, and the like.

With respect to the ratio of the polyphenylene ether resin (A) to the aromatic vinyl resin (B), it is necessary that the amount of the polyphenylene ether resin (A) be in the range of 30 to 100 parts by weight and the amount of the aromatic vinyl resin (B) be in the range of 0 to 70 parts by weight, the total amount being 100 parts by weight. More preferably, the amount of the polyphenylene ether resin (A) is 30 to 95 parts by weight, and the amount of the aromatic vinyl resin (B) is 5 to 70 parts by weight. If the amount of the polyphenylene ether resin (A) is less than 30 parts by weight, mechanical properties are degraded, which is not desirable.

A silicone compound, which is the component (C) of the present invention, is an aromatic group-containing organosiloxane compound and is represented by the average compositional formula:
R¹ₘR²ₙSiO_{(4-m-n)/2} (1)
(wherein R¹ represents a monovalent aliphatic hydrocarbon group having 1 to 4 carbon atoms; R² represents a monovalent aromatic hydrocarbon group having 6 to 24 carbon atoms; there may be two or more R¹s and two or more R²s; and m and n each represent a number satisfying the relationships: 1.1≦m+n≦1.7 and 0.4≦n/m≦2.5), the silicone compound having a SiO₂ unit in an amount of 10 mole percent or more of all Si atoms. The silicone compound is composed of, besides the Q unit (SiO₂) which is the essential constituent, any combination of three constitutional units: a T unit (RSiO_{1.5}), a D unit (R₂SiO), and a M unit (R₃SiO_{0.5}), wherein R represents an aromatic hydrocarbon group or an aliphatic hydrocarbon group.

The aromatic group-containing organosiloxane compound represented by average compositional formula (I) satisfies the following conditions: the compound has both a monovalent aliphatic hydrocarbon group R¹ having 1 to 4 carbon atoms and a monovalent aromatic hydrocarbon group R² having 6 to 24 carbon atoms in its molecule; the molar ratio of the total hydrocarbon group to the number of Si atoms, i.e., m+n, is in the range of 1.1≦m+n≦1.7; and the molar ratio of the monovalent aromatic hydrocarbon group R² having 6 to 24 carbon atoms to the monovalent aliphatic hydrocarbon group R¹ having 1 to 4 carbon atoms, i.e., n/m, is in the range of 0.4≦n/m≦2.5. Ratios of the elements and hydrocarbon groups can be calculated by means of H-NMR, C-NMR, and Si-NMR.

The aliphatic hydrocarbon group R¹ having 1 to 4 carbon atoms is not particularly limited. Examples thereof include a methyl group, an ethyl group, a n-propyl group, an i-propyl group, a n-butyl group, a sec-butyl group, and a tert-butyl group. Among these, a methyl group and an ethyl group are preferred, and a methyl group is more preferred because of excellent effect of imparting flame retardancy. The silicone compound (C) contains a plurality of group corresponding to R¹s that may be the same or different. When the aliphatic hydrocarbon group has 5 or more carbon atoms, the flame retardancy of the aromatic group-containing organosiloxane compound itself decreases, resulting in a decrease in the effect of imparting flame retardancy.

The aromatic hydrocarbon group R² having 6 to 24 carbon atoms is not particularly limited. Examples thereof include a phenyl group, a methylphenyl group, a dimethylphenyl group, an ethylphenyl group, a naphthyl group, and an anthracenyl group. Among these, an aromatic group not having a substituent on the aromatic ring is preferred, and a phenyl group is more preferred because of excellent effect of imparting flame retardancy. The silicone compound (C) contains a plurality of groups corresponding to R²s that may be the same or different.

The molar ratio of the total hydrocarbon group to the number of Si atoms, i.e., m+n, is in the range of 1.1≦m+n≦1.7, preferably 1.15≦m+n≦1.65, more preferably 1.18≦m+n≦1.6, and still more preferably 1.20≦m+n≦1.55. When the value m+n is less than 1.1 or exceeds 1.7, the effect of imparting flame retardancy of the aromatic group-containing organosiloxane compound tends to undesirably decrease. By introducing the Q unit in a certain amount or more into the skeleton of the organosiloxane compound, a structure satisfying the range described above can be formed. In general, as the amount of the unit introduced increases, the range described above can be more easily achieved. The amount of the Q unit introduced is preferably 10 mole percent or more, more preferably 15 mole percent or more, and most preferably 20 mole percent or more of all Si atoms. As the amount of the Q unit introduced increases, compatibility between the silicone compound and a metal silicate compound of the component (D) of the present invention having the same SiO₂ structure is improved, and thus, the effect of imparting flame retardancy further improves synergistically.

The molar ratio of the monovalent aromatic hydrocarbon group R² having 6 to 24 carbon atoms to the monovalent aliphatic hydrocarbon group R¹ having 1 to 4 carbon atoms, i.e., n/m, is in the range of 0.4≦n/m≦2.5. When n/m is less than 0.4, the number of monovalent aliphatic hydrocarbon groups R¹ is increased in its molecule. In this case, the heat resistance of the aromatic group-containing organosiloxane compound is decreased, resulting in a decrease in the effect of imparting flame retardancy of the aromatic group-containing organosiloxane compound. On the other hand, the ratio n/m exceeding 2.5 also results in a decrease in the effect of imparting flame retardancy of the aromatic group-containing organosiloxane compound. The value n/m is preferably in the range of 0.43≦n/m≦2.3, more preferably 0.45≦n/m≦2.1, and still more preferably 0.47≦n/m≦2.0.

A preferred example of the structure of the aromatic group-containing organosiloxane compound is a structure in which the main chain skeleton contains 10 mole percent or more of the Q unit, and the remainder is composed of the T unit and the D unit. Another preferred example is a structure in which the main chain skeleton is composed of only the Q unit and the T unit or composed of only the Q unit and the D unit. Preferably, termini of the main chain skeleton are blocked with the M units. If silanol groups or alkoxysilyl groups remain at the termini, flame retardancy may be degraded or the properties of the resin may be adversely affected.

Such an aromatic group-containing organosiloxane compound can be easily synthesized by a known method for synthesizing a silicone. That is, the compound can be synthesized by condensation reaction of at least one silicon compound and preferably at least two silicon compounds selected from organic silicon compounds, such as monofunctional silicon compounds represented by R₃SiX, bifunctional silicon compounds represented by R₂SiX₂, trifunctional silicon compounds represented by RSiX₃, silicon tetrahalides, tetraalkoxysilanes, and condensates thereof, and inorganic silicon compounds, such as water glass and metal silicates, according to need, wherein R represents an aromatic hydrocarbon group or an aliphatic hydrocarbon group; and X represents a group capable of forming a siloxane bond by condensation, such as a halogen, a hydroxyl group, or an alkoxy group.

Reaction conditions vary depending on a substrate used and the composition and the molecular weight of a target compound. In general, the reaction can be performed by mixing a silicon compound, as necessary, in the presence of water, an acid, and/or an organic solvent, under heating, if required. The ratio of the silicon compounds used may be appropriately determined taking into consideration the content of each unit and the ratio of the aromatic hydrocarbon group to the aliphatic hydrocarbon group so that the resulting aromatic group-containing organosiloxane compound satisfies the conditions described above.

Further, the organosiloxane compound has a number-average molecular weight in the range of 1,000 to 200,000, preferably 1,500 to 150,000, and more preferably 2,000 to 100,000. In general, in the silicone compounds described in Background Art, the molecular weight and flame retardancy are discussed. In the present invention, the heat resistance of the silicone can be controlled by optionally determining content of the siloxane bond in its molecule. When the number-average molecular weight is less than 1,000, the organopolysiloxane has low heat resistance and also has insufficient flame retardancy. A number-average molecular weight exceeding 200,000 gives rise to problems, such as poor dispersibility in a resin and poor moldability.

The amount of the silicone compound (C) to be added in the present invention is 0.1 to 20 parts by weight per 100 parts by weight of a thermoplastic resin including the polyphenylene ether resin (A) and the aromatic vinyl resin (B). In view of expression of physical properties and economics, the amount of addition is preferably 0.3 to 15 parts by weight, and most preferably 0.5 to 10 parts by weight. If the amount of the silicone compound (C) added is less than 0.1 parts by weight, in some cases, flame retardancy may be insufficient. An amount of addition exceeding 20 parts by weight is uneconomical although there is no particular problem in terms of physical properties.

A metal silicate compound (D) of the present invention has a pH of 8.0 or more, contains 30% by weight or more of a SiO₂ unit, and has a volume-average particle size of 1 nm to 100 μm. This component is added in combination with a specific silicone compound in order to enhance the effect of imparting flame retardancy. The content of the SiO₂ unit is 30% by weight or more, and in view of flame retardancy, preferably 35% by weight or more and most preferably 40% by weight or more.

The metal silicate compound used as the component (D) containing 30% by weight or more of the SiO₂ unit is not particularly limited and preferably, it contains at least one metal element selected from K, Na, Li, Ca, Mn, Ni, Mg, Fe, Al, Ti, Zn, and Zr. Specific examples of the metal silicate compound include magnesium silicate, aluminum silicate, calcium silicate, talc, mica, wollastonite, kaolin, diatomaceous earth, and smectite. Among these, mica, talc, kaolin, or smectite is preferable because of excellent flame retardancy and mechanical strength of the resulting resin composition.

The metal silicate compound (D) is in the form of fine particles having a volume-average particle size of 1 nm to 100 μm. If the volume-average particle size exceeds 100 μm, the appearance of the resulting molded article tends to be impaired or the impact strength of the resin composition tends to be decreased. The volume-average particle size is preferably 1 nm to 70 μm, more preferably 10 nm to 50 μm, and still more preferably 0.5 to 30 μm. In the present invention, the volume-average particle size can be measured by a laser diffraction/scattering method.

The shape of the metal silicate compound (D) is not particularly limited, but is typically powdery, granular, acicular, plate-like, or the like. The inorganic compound may be a natural product or a synthetic material. In the case of the natural product, the source and the like thereof are not particularly limited, and the material may be appropriately selected.

The metal silicate compound (D) of the present invention has a pH of 8.0 or more. The fact that the metal silicate compound has a pH of 8.0 or more means that the compound has ionic bonding nature between silicate anions and metal cations. Although the metal silicate itself is thermally stable, when a silicone compound coexists, the metal silicate chemically interacts with the silicone compound at high-temperatures because of its ionic bonding nature, thereby synergistically affecting flame retardancy. The pH in the present invention can be measured in accordance with JIS-K-5101 Method B.

The metal silicate compound (D) may be subjected to surface treatment with any of various surface treatment agents, such as a silane treatment agent, in order to enhance adhesion to a resin. The surface treatment agent is not particularly limited, and any known one may be used. An epoxy group-containing silane coupling agent, such as epoxysilane, and an amino group-containing silane coupling agent, such as aminosilane, are preferred because physical properties of the resin are not significantly degraded. In addition, polyoxyethylenesilane or the like may be used. Any of known surface-treating methods can be used without particular limitations.

The metal silicate compound (D) may be used alone. Alternatively, two or more metal silicate compounds (D) that are different in average particle size, type, surface treatment agent applied, and the like may be used in combination.

In the thermoplastic resin composition of the present invention, the amount of the metal silicate compound (D) used is 0.1 to 20 parts by weight per 100 parts by weight of the total of two components, i.e., the polyphenylene ether resin (A) and the aromatic vinyl resin (B). If the amount is less than 0.1 parts by weight, the flame retardancy of the resulting resin composition becomes insufficient. On the other hand, if the amount exceeds 20 parts by weight, the flame retardancy and impact resistance of the resulting molded article are decreased, and it tends to be difficult to knead the metal silicate compound and the resin during melt-kneading. The amount of the metal silicate compound (D) is preferably 0.3 to 15 parts by weight and more preferably 0.5 to 10 parts by weight.

A fluorocarbon resin (E) used in the present invention is a resin containing a fluorine atom. Specific examples thereof include fluorinated polyolefin resins, such as polymonofluoroethylene, polydifluoroethylene, polytrifluoroethylene, polytetrafluoroethylene, and tetrafluoroethylene/hexafluoropropylene copolymers; and polyvinylidene fluorides. Furthermore, a copolymer prepared by polymerization of a monomer used for the production of the fluorocarbon resin and a monomer copolymerizable therewith may be used.

The fluorocarbon resin (E) is preferably a fluorinated polyolefin resin and more preferably a fluorinated polyolefin resin having an average particle size of 700 μm or less. The term “average particle size” is defined herein as the average particle size of secondary particles formed by aggregation of primary particles of the fluorinated polyolefin resin.

Furthermore, the fluorinated polyolefin resin is preferably a fluorinated polyolefin resin having a ratio of density to bulk density (density/bulk density) of 6.0 or less. The terms “density” and “bulk density” defined herein refer to those measured in accordance with a method described in JIS-K-6891.

The fluorocarbon resin (E) may be used alone, or in combination of two or more fluorocarbon resins (E). When two or more fluorocarbon resins (E) are used in combination, the combination is not limited. For example, different types of fluorocarbon resin (E) may be used in any combination.

The amount of the fluorocarbon resin (E) used is 0.005 to 1 part by weight, preferably 0.01 to 0.75 parts by weight, and more preferably 0.02 to 0.6 parts by weight, per 100 parts by weight of the total of two components, i.e., the polyphenylene ether resin (A) and the aromatic vinyl resin (B). If the amount of use is less than 0.005 parts by weight, the effect of improving flame retardancy may be small. If the amount of use exceeds 1 part by weight, the flowability in molding of the flame-retardant resin composition of the present invention and the surface appearance of the resulting molded article may be degraded.

In the present invention, the deflection temperature under a load of 1.82 MPa was measured using an ASTM strip specimen of ¼ inch (about 6.4 mm) wide by ½ inch (12.5 mm) high by 5 inch (125.7 mm) long in accordance with ASTM test method D648. The resin composition of the present invention preferably has a deflection temperature of 135° C. or higher under a load of 1.82 MPa. If the deflection temperature under load is lower than 135° C., in some cases, it may not be possible to satisfy the required long-term dimensional stability in the use environment of advanced electronic, electrical, and OA equipment components.

In order to further enhance flowability in molding and improve flame retardancy, a silicone compound or the like other than the silicone compound of the present invention may be added to the flame-retardant resin composition of the present invention to the extent that the properties (flame retardancy and the like) of the present invention is not impaired.

The silicone compound refers to a polyorganosiloxane in a broad sense. Examples thereof include (poly)diorganosiloxane compounds, such as dimethylsiloxane and phenylmethylsiloxane; (poly)organosilsesquioxane compounds, such as methylsilsesquioxane and phenylsilsesquioxane; (poly)triorganosilhemioxane compounds, such as trimethylsilhemioxane and triphenylsilhemioxane; copolymers obtained by polymerization thereof; and polydimethylsiloxane and polyphenylmethylsiloxane. When the silicone compound is a polyorganosiloxane, a modified silicone in which the terminus of its molecule is substituted with an epoxy group, a hydroxyl group, a carboxyl group, a mercapto group, an amino group, an ether group, or the like is also useful. The form of the silicone is not particularly limited, and any form, such as an oily, rubbery, varnish, powdery, or pellet form, can be used.

Furthermore, in order to enhance the heat resistance and mechanical strength of the resin composition, a reinforcing filler other than the metal silicate compound (D) can be added to the flame-retardant resin composition of the present invention. The reinforcing filler is not particularly limited. Examples thereof include fibrous reinforcements, such as glass fiber, carbon fiber, and metal fiber; metal oxides, such as titanium oxide and iron oxide; and calcium carbonate, glass beads, glass powder, ceramic powder, metal powder, and carbon black. These reinforcing fillers may be used alone. Alternatively, two or more reinforcing fillers that are different in type, particle size or length, surface treatment, and the like may be used in combination.

The reinforcing filler may be subjected to surface treatment in order to enhance adhesion to a resin. The surface treatment agent used for performing such surface treatment is not particularly limited. An epoxy group-containing silane coupling agent, such as epoxysilane, is preferable because it does not degrade physical properties of the resin. The surface-treating method is not particularly limited, and any known surface-treating method may be used.

When the reinforcing filler is used, the amount of the reinforcing filler added is 100 parts by weight or less per 100 parts by weight of the total of the polyphenylene ether resin (A) and the aromatic vinyl resin (B). If the amount of addition exceeds 100 parts by weight, impact resistance is decreased, and moldability and flame retardancy may be degraded. The amount of addition is preferably 50 parts by weight or less and more preferably 10 parts by weight or less. Furthermore, as the amount of the reinforcing filler added increases, surface properties and dimensional stability of a molded article tend to degrade. Thus, when these properties are important, it is preferred to decrease as much as possible the amount of the reinforcing filler added.

To the extent that the properties of the flame-retardant resin composition of the present invention is not impaired, it may be possible to add any other thermoplastic or thermosetting resin, such as a polyester resin, a polyamide resin, a polyphenylene sulfide resin, a polyacetal resin, a polysulfone resin, a polyolefin resin, or a rubbery elastomer. These resins may be incorporated alone or in combination of two or more.

Furthermore, in order to enhance the performance of the flame-retardant resin composition of the present invention, it is preferable to use an antioxidant, such as a phenolic antioxidant or a thioether antioxidant, and a heat stabilizer, such as a phosphorus-containing stabilizer, alone or in combination of two or more. According to need, commonly known additives, such as a stabilizer, a lubricant, a mold-releasing agent, a plasticizer, an ultraviolet absorber, a light stabilizer, a pigment, a dye, an antistatic agent, a conductivity-imparting agent, a dispersant, a compatibilizer, and an antibacterial agent, may be used alone or in combination of two or more.

The method for molding the flame-retardant resin composition produced in the present invention is not particularly limited. A commonly used method for molding a thermoplastic resin, for example, injection molding, blow molding, extrusion molding, vacuum molding, press molding, or calendar molding, may be employed.

### EXAMPLES

The present invention will be described below in more detail based on examples, but the present invention is not limited thereto. Hereinafter, “part” means part by weight, and “%” means percent by weight, unless otherwise specified.

### Production Example 1

### Production of Silicone Compound (C1)

Dichlorodiphenylsilane (253 g), trichlorophenylsilane (179 g), dichlorodimethylsilane (80 g), and M Silicate 51 (291 g; manufactured by Tama Chemicals Co., Ltd.) were weighed and placed in a 5-L flask. After addition of methyl isobutyl ketone (hereinafter referred to as “MIBK”) (1,200 g), water (395 g) was added dropwise thereto at 10° C. or lower. Subsequently, the reaction mixture was heated to 80° C. and reaction was carried out for 3 hours. After the reaction mixture was cooled to room temperature, chlorotrimethylsilane (317 g) and then water (52 g) were added dropwise thereto, followed by reaction at 60° C. for 3 hours. The resulting reaction mixture was washed with water until neutral. The solvent in a separated organic phase was distilled off under reduced pressure to give the target silicone compound (C1). GPC analysis showed that the molecular weights of the product were Mn=3,229 and Mw=4,215 (in terms of polystyrene, RI detection). NMR analysis showed that constitutional ratios in average compositional formula (1) were m=0.80 and n=0.57, resulting in m+n=1.37 and n/m=0.71.

### Production Example 2

### Production of Silicone Compound (C2)

Trichlorophenylsilane (200 g) and M Silicate 51 (110 g; manufactured by Tama Chemicals Co., Ltd.) were weighed and placed in a 3-L flask. After addition of MIBK (800 g), water (100 g) was added dropwise thereto at 10° C. or lower. Subsequently, the reaction mixture was heated to 80° C. and reaction was carried out for 3 hours. After the reaction mixture was cooled to room temperature, chlorotrimethylsilane (100 g) and then water (15 g) were added dropwise thereto, followed by reaction at 60° C. for 3 hours. The resulting reaction mixture was washed with water until neutral. The solvent in a separated organic phase was distilled off under reduced pressure to give the target silicone compound (C2). GPC analysis showed that the molecular weights of the product were Mn=2,583 and Mw=3,355 (in terms of polystyrene, RI detection). NMR analysis showed that constitutional ratios in average compositional formula (I) were m=1.07 and n=0.46, resulting in m+n=1.53 and n/m=0.43.

### Production Example 3

### Production of Silicone Compound (C3)

Dichlorodiphenylsilane (468 g), dichlorodimethylsilane (80 g), and M Silicate 51 (291 g; manufactured by Tama Chemicals Co., Ltd.) were weighed and placed in a 5-L flask. After addition of MIBK (1,200 g), water (336 g) was added dropwise thereto at 10° C. or lower. Subsequently, the reaction mixture was heated to 80° C. and reaction was carried out for 3 hours. After the reaction mixture was cooled to room temperature, chlorotrimethylsilane (268 g) and then water (44 g) were added dropwise thereto, followed by reaction at 60° C. for 3 hours. The resulting reaction mixture was washed with water until neutral. The solvent in a separated organic phase was distilled off under reduced pressure to give the target silicone compound (C3). GPC analysis showed that the molecular weights of the product were Mn=2,660 and Mw=3,585 (in terms of polystyrene, RI detection). NMR analysis showed that constitutional ratios in average compositional formula (I) were m=0.82 and n=0.60, resulting in m+n=1.42 and n/m=1.37.

### Reference Production Example 1

### Production of Organosiloxane Compound (C4)

Methyltrichlorosilane (637 g) and dichlorodiphenylsilane (299 g) were weighed and placed in a 6-L flask. After addition of MIBK (2,500 ml), water (1,040 g) was added dropwise thereto at 10° C. or lower. Subsequently, the reaction mixture was heated to 80° C. and reaction was carried out for 3 hours. The resulting reaction mixture was washed with water until neutral. The solvent in a separated organic phase was distilled off under reduced pressure to give the target organosiloxane compound (C4). GPC analysis showed that the molecular weights of the product were Mn=2,467 and Mw=3,535 (in terms of polystyrene, RI detection). NMR analysis showed that constitutional ratios in average compositional formula (1) were m=0.60 and n=0.33, resulting in m+n=0.93 and n/m=0.55.

Starting materials used in Examples and Comparative Examples are summarized below.

(PPE): Poly(2,6-dimethyl-1,4-phenylene) ether resin (PX100F, manufactured by Mitsubishi Engineering-Plastics Corporation) having an inherent viscosity of 0.50

(PS): Polystyrene resin (Estyrene G-13, manufactured by Nippon Steel Chemical Co., Ltd.)

(HIPS): Butadiene-styrene copolymer (Estyrene H1 H-53, manufactured by Nippon Steel Chemical Co., Ltd.)

(C5): Octaphenylsilsesquioxane (MS0840, manufactured by Hybrid Plastics, Inc.)

(P1): Aromatic phosphate ester (FP-700, manufactured by ADEKA Corporation)

(D1): Talc (SG-200, manufactured by Nippon Talc Co., Ltd., pH=9.3, SiO₂ unit content=60% by weight, volume-average particle size=3.2 μm)

(D2): Mica (A-21S, manufactured by Yamaguchi Mica Co., Ltd., pH=8.0, SiO₂ unit content=45% by weight, volume-average particle size=22.5 μm)

(Fluorocarbon resin): Tetrafluoroethylene (Polyflon FA-500, manufactured by Daikin Industries, Ltd.) (hereinafter abbreviated as “PTFE”)

### Example 1

### Preparation of Resin Composition

First, 90 parts by weight of a polyphenylene ether resin (PPE), 10 parts by weight of a polystyrene resin (PS), 2 parts by weight of the silicone compound (C1) manufactured in Production Example 1, 1 part by weight of talc (D1), 0.1 parts by weight each of a phosphorus-containing stabilizer and a phenolic stabilizer, i.e., ADK STAB HP-10 and AO-60 respectively (each manufactured by ADEKA Corporation), and 0.2 parts by weight of PTFE were dry-blended in advance. The mixture was fed into a vented twin-screw extruder (trade name: TEX44, manufactured by The Japan Steel Works, LTD.) through a hopper thereof, in which the cylinder temperature was set at 300° C., and melt extrusion was performed to obtain a resin composition.

Formation of Specimen

The resulting pellets were dried at 120° C. for 5 hours. The dry pellets were molded with a 35-t injection molding machine at a cylinder temperature of 295° C. and a die temperature of 50° C. to form 1.6 mm thick bars (12 mm wide and 127 mm long). The following evaluation was performed. The results thereof are shown in Table 1.

Evaluation Method

Evaluation of flame retardancy was performed in accordance with the UL-94 V test to determine the total combustion time in seconds.

### Examples 2 to 14 and Comparative Examples 1 to 6

Resin compositions were obtained as in Example 1 except that the types of resins, silicone compounds, and metal silicate compounds and the amounts of addition were changed. The resulting pellets were formed into specimens in the same manner as described above. Evaluation results thereof are shown in Tables 1 and 2.

[TABLE 1]

TABLE 1

| | | EXAMPLES | | | | | | | | | | | | | |
|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 |
| Polyphenylene | PPE | 90 | 90 | 90 | 80 | 80 | 80 | 80 | 80 | 80 | 80 | 80 | 70 | 70 | 70 |
| ether resin | | | | | | | | | | | | | | | |
| Aromatic | PS | 10 | | | 20 | 20 | 20 | 20 | 20 | 20 | | | 30 | 30 | |
| vinyl resin | HIPS | | 10 | 10 | | | | | | | 20 | 20 | | | 30 |
| Silicone | C1 | 2 | | | 3 | 3 | 3 | 6 | | | | | | | |
| compound | C2 | | 2 | | | | | | 6 | | 6 | | | | 6 |
| | C3 | | | 1 | | | | | | 6 | | 6 | 6 | 6 | |
| Metal | D1 | 1 | | 3 | 1 | 5 | | | 5 | 5 | 5 | 5 | 5 | | |
| silicate | D2 | | 3 | | | | 1 | 5 | | | | | | 5 | 5 |
| Fluorocarbon | PTFE | 0.2 | 0.2 | 0.2 | 0.2 | 0.2 | 0.2 | 0.2 | 0.2 | 0.2 | 0.2 | 0.2 | 0.2 | 0.2 | 0.2 |
| resin | | | | | | | | | | | | | | | |

| | | | | | | | | | | | | | | |
|---|---|---|---|---|---|---|---|---|---|---|---|---|---|---|
| Total combustion | 32 | 35 | 28 | 75 | 67 | 68 | 44 | 42 | 40 | 43 | 42 | 49 | 50 | 51 |
| time in seconds | | | | | | | | | | | | | | |
| (sec.) | | | | | | | | | | | | | | |
| HDT (° C.) | 172 | 172 | 172 | 158 | 158 | 158 | 157 | 158 | 157 | 157 | 157 | 146 | 146 | 146 |

[TABLE 2]

TABLE 2

| | | COMPARATIVE EXAMPLES | | | | | |
|---|---|---|---|---|---|---|---|
| | | 1 | 2 | 3 | 4 | 5 | 6 |
| Polyphenylene | PPE | 80 | 80 | 80 | 80 | 80 | 80 |
| ether resin | | | | | | | |
| Aromatic | PS | 20 | 20 | | 20 | 20 | 20 |
| vinyl resin | HIPS | | | 20 | | | |
| Silicone | C1 | 3 | | | | | |
| compound | C4 | | | | 5 | | |
| | C5 | | | | | 3 | |
| Phosphate | P1 | | | | | | 9 |
| ester | | | | | | | |
| Metal | D1 | | 5 | | 5 | 5 | |
| silicate | D2 | | | 5 | | | |
| Fluorocarbon | PTFE | 0.2 | 0.2 | 0.2 | 0.2 | 0.2 | 0.2 |
| resin | | | | | | | |

| | | | | | | |
|---|---|---|---|---|---|---|
| Total combustion | 150 | 211 | 230 | 129 | 163 | 68 |
| time in seconds | | | | | | |
| (sec.) | | | | | | |
| HDT (° C.) | 158 | 161 | 159 | 160 | 160 | 134 |

As shown in Table 1, in all of Examples, very good flame retardancy was obtained, and the resin compositions were self-extinguished in a short period of time. In each of Comparative Examples 1 to 3, in which the silicone compound or the metal silicate compound was used alone, flame retardancy was insufficient. In each of Comparative Examples 4 and 5, since the silicone compound different from that of the present invention was used as the flame retardant, the effect of imparting flame retardancy was insufficient. As is evident from Table 1, by forming the compositions of the present invention, it is possible to provide resin compositions having excellent flame retardancy.

1. A flame-retardant resin composition comprising:
a resin component including 30 to 100 parts by weight of a polyphenylene ether resin (A) and 0 to 70 parts by weight of an aromatic vinyl resin (B);
a silicone compound (C) in an amount of 0.1 to 20 parts by weight per 100 parts by weight of the resin component, the silicone compound being represented by average compositional formula (I):
R¹ₘR²ₙSiO_{(4-m-n)/2} (1)
(wherein R¹ represents a monovalent aliphatic hydrocarbon group having 1 to 4 carbon atoms; R² represents a monovalent aromatic hydrocarbon group having 6 to 24 carbon atoms; there may be two or more kinds of R¹s and two or more kinds of R²s, respectively; and m and n each represent a number satisfying the relationships: 1.1≦m+n≦1.7 and 0.4≦n/m≦2.5), the silicone compound having a SiO₂ unit in an amount of 10 mole percent or more of all Si atoms; and
a metal silicate compound (D) in an amount of 0.1 to 20 parts by weight per 100 parts by weight of the resin component, the metal silicate compound having a pH of 8.0 or more, containing 30% by weight or more of a SiO₂ unit, and having a volume-average particle size of 1 nm to 100 μm.

2. The flame-retardant resin composition according to claim 1, wherein the resin component includes 30 to 95 parts by weight of the polyphenylene ether resin (A) and 5 to 70 parts by weight of the aromatic vinyl resin (B).

3. The flame-retardant resin composition according to claim 1, further comprising 0.005 to 1 part by weight of a fluorocarbon resin (E).

4. The flame-retardant resin composition according to claim 1, wherein the silicone compound as the component (C) has a R³SiO_{3/2} unit (wherein R³ is selected from the group consisting of alkyl groups having 1 to 4 carbon atoms and aromatic groups having 6 to 24 carbon atoms, and R³s may be the same or different) and a R⁴₂SiO_{2/2} unit (wherein each R⁴ is selected from the group consisting of alkyl groups having 1 to 4 carbon atoms and aromatic groups having 6 to 24 carbon atoms, and R⁴s may be the same or different).

5. The flame-retardant resin composition according to claim 1, wherein the silicone compound as the component (C) has a main chain skeleton composed of only a R³SiO_{3/2} unit (wherein R³ is selected from the group consisting of alkyl groups having 1 to 4 carbon atoms and aromatic groups having 6 to 24 carbon atoms, and R^{3s} may be the same or different) and a SiO₂ unit.

6. The flame-retardant resin composition according to claim 1, wherein the silicone compound as the component (C) has a main chain skeleton composed of only a R⁴₂SiO_{2/2} unit (wherein each R⁴ is selected from the group consisting of alkyl groups having 1 to 4 carbon atoms and aromatic groups having 6 to 24 carbon atoms, and R⁴s may be the same or different) and a SiO₂ unit.

7. The flame-retardant resin composition according to claim 1, wherein the silicone compound as the component (C) has a number-average molecular weight in the range of 1,000 to 200,000.

8. The flame-retardant resin composition according to claim 1, wherein the metal silicate compound as the component (D) contains at least one metal element selected from K, Na, Li, Ca, Mn, Ni, Mg, Fe, Al, Ti, Zn, and Zr.

9. The flame-retardant resin composition according to claim 1, wherein the resin composition has a deflection temperature of 135° C. or higher under a load of 1.82 MPa.
